(19) United States
(12) Patent Application Publication
(10) Pub. No.: US 2022/0257462 A1
(43) Pub. Date: Aug. 18, 2022

(54) VIBRATING GLOVE FOR STIMULATION

(71) Applicant: David McCoy, SW Marietta, GA (US)

(72) Inventor: David McCoy, SW Marietta, GA (US)

(21) Appl. No.: 17/736,172

(22) Filed: May 4, 2022

Related U.S. Application Data
(60) Provisional application No. 63/183,707, filed on May 4, 2021.

(51) Int. Cl. A61H 23/02; A61H 19/00; A41D 19/00

(52) U.S. Cl. CPC A61H 23/02; A61H 19/00; A41D 19/0024; A61H 2201/5097; A41D 2400/322; A61H 2201/165; A61H 2201/1635; A61H 2201/5002; A61H 2201/1692

(57) ABSTRACT

A vibrating glove comprises an elastic material based glove comprising a textured surface on the palm region and a plurality of finger portions having rugged surfaces, a plurality of vibration motors; a rechargeable port connected to a rechargeable battery; the plurality of vibration motors, the rechargeable battery connected to the rechargeable port, being positioned within the elastic glove under the outer cover, the rechargeable port connected to the recharagble battery is positioned near the wrist portion, a plurality of modes for vibration, an illuminating means, a vibration and illumination mode depending upon the mood of the user, to enjoy the simulation of the body part.

### TECHNICAL FIELD

The present invention generally relates to gloves. More specifically the present invention relates to a vibrating glove designed to be used during sexual activities.

### BACKGROUND

The following description includes information that may be useful in understanding the present invention. It is not an admission that any of the information provided herein is prior art or relevant to the presently claimed invention, or that any publication specifically or implicitly referenced is prior art.

In the past, many apparatuses and devices have been developed to be used in conjunction with sexual activities. These sexual activities may be carried out by a sole participant or by two or even more than two. It is the purpose of sex apparatuses to aid in the achievement of orgasmic pleasure.

Sex apparatuses in existence include devices such as phallic substitutes, vaginal substitutes, and vibrating stimulators. Such devices may be used either in conjunction with a sex act between two or more participants as an enhancement to the sexual pleasure or as a substitute for sexual contact between the participants.

Sexual apparatuses are widely regarded as effective at aiding females in achieving erogenic pleasure and or orgasm. Additionally sex apparatuses carry no risk of the user being afflicted by sexually transmitted diseases (STDs) such as AIDS or others diseases, as long as the sex apparatus is not used by more than one person. One of the most popular forms of erogenic stimulation used by females is manual manipulation of the genitals. The manual manipulation such as touching, rubbing or inserting is done by hand's fingers. There are also some sex apparatuses on the market that are meant to improve the act of manually stimulating the genitals. These apparatuses include finger attachments and hand worn gloves which contain vibrating components to more effectively stimulate the erogenous zones.

These devices suffer from being too bulky and as a result are not as effective as sex apparatuses as they could be. It is therefore an object of the present invention to create a sex apparatus which is designed to be worn on the hand of a user like a glove.

It is a further object of the present invention to provide vibratory components to aid in stimulation of the erogenous zones without making the apparatus to large and bulky or without any discomfort or harm to user sensitive genital area.

### SUMMARY OF THE INVENTION

The present invention relates to a vibrating glove that is designed to be used during sexual activities. The vibrating glove is shaped to perfectly fit over a human hand.

The vibrating glove may be made from elastic or one of the materials used for clothing.

The vibrating means are present inside of the gloves which is not physically touching the wearer's skin.

The vibrating glove may have textures or with dotted or rugged surface on the figure tips and thumb.

The vibrating glove comprises vibrating means for producing vibrations while in use.

The vibrating gloves may contain a rechargeable and replaceable battery. The battery can be replaced with another set of batteries or recharge using ac current.

A charging port is provided to charge the batteries. The batteries are used to provide charge to the vibrating motors to produce vibrations in different modes.

The various modes are designed to provide the vibrations at different intensities and different fingers. The modes are depending upon the mood of the user.

An illuminating means can also be provided to the vibrating glove, which changes the illuminations in terms of colors and intensity to enhance the mood of the user.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1 illustrates a perspective side view of the vibrating glove, according to an embodiment of the present invention.

FIG. 2 illustrates a palm side view of the vibrating glove, according to an embodiment of the present invention.

FIG. 3 illustrates the side view of the vibrating glove, according to an embodiment of the present invention.

FIG. 4 illustrates the back side view of the vibrating glove, according to an embodiment of the present invention.

### DETAILED DESCRIPTION OF DRAWINGS

The following detailed description is made with reference to the invention as disclosed. Preferred implementations are described to illustrate the invention disclosed, not to limit its scope, which is defined by the claims. Those of ordinary skill in the art will recognize a variety of equivalent variations on the description.

Thus, for example, it will be appreciated by those of ordinary skill in the art that the diagrams, schematics, illustrations, and the like represent conceptual views or processes illustrating systems and methods embodying this invention.

The present invention relates to a vibrating glove that is designed to be used during sexual activities. The vibrating glove is shaped to perfectly fit over a human hand.

A vibrating glove comprises an elastic material based glove comprising a textured surface on the palm region and a plurality of finger portions having rugged surfaces, a plurality of vibration motors; a rechargeable port connected to a rechargeable battery; the plurality of vibration motors, the rechargeable battery connected to the rechargeable port, being positioned within the elastic glove under the outer cover, the rechargeable port connected to the recharagble battery is positioned near the wrist portion, a plurality of modes for vibration, an illuminating means, a vibration and illumination mode depending upon the mood of the user, to enjoy the simulation of the body part.

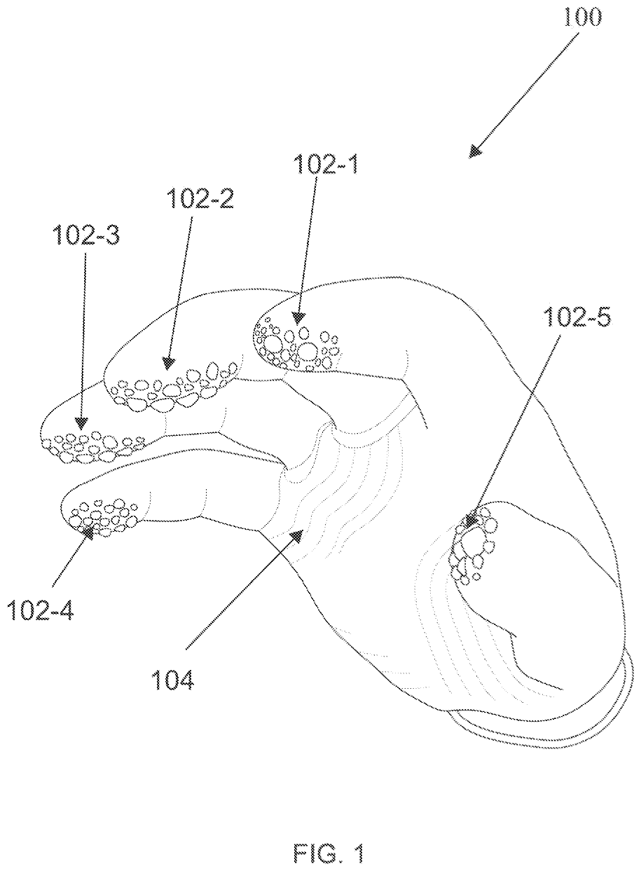

FIG. 1 illustrates a perspective view of the vibrating glove 100, according to an embodiment of the present invention. As illustrated, the palm section includes the textured surface and the plurality of finger tips and thumbs comprises the vibrating elements 102-1 to 102-5, for producing the vibrations for simulation of body parts. The vibrating means are connected to each other or to palm vibrating element under the glove.

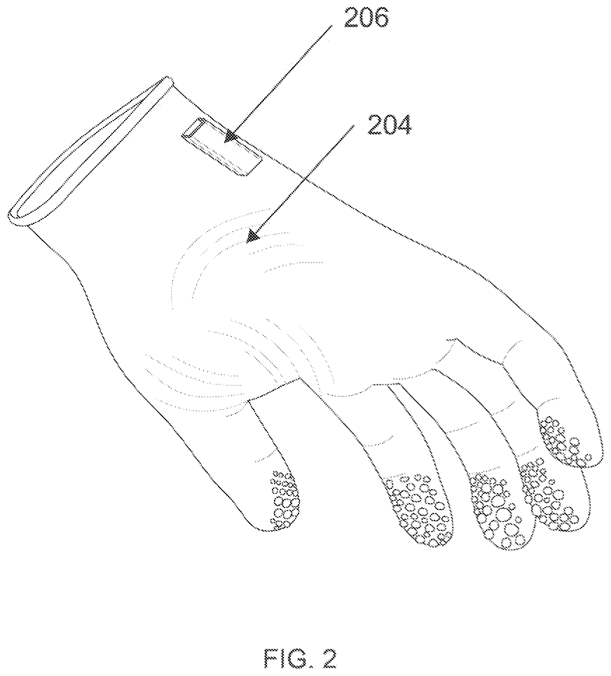

FIG. 2 illustrates a palm side view of the vibrating glove, according to an embodiment of the present invention. As illustrated, the palm side comprises textured regions 204 and a rechargeable port 206 to charge the battery (not shown).

The vibrating glove may further comprise a wireless module to provide wireless module and an illuminating means. The various modules in the vibrating gloves are configured to be integrated in a chip level integration. However, it might be possible that design may have different modules arranged in a different way based on proof of work basis. The modules can also be present on the same side or end of the globe on the arm side for the comfortability of the use.

The vibrating glove comprises vibrating means for producing vibrations while in use. The vibrating means is present inside of the gloves which is not physically touching the wearer's skin.

The vibrating glove comprises a plurality of vibrating means, a rechargeable battery, a wireless module, a lighting module, an electrical switch. In the preferred embodiment, the plurality of vibration means, the rechargeable battery, the wireless module and a switch are positioned within the material of the vibrating glove and around the wrist side of the vibrating glove.

In the preferred embodiment, the vibrating means may be vibrating motors which are present in the palm area and along the fingers. The vibrating means can produce vibrations of different intensity. The intensity can be controlled by a remote control.

In the preferred embodiment, the remote control can be controlled by a wireless module or can be connected to the vibrating glove through other means such as IR and other wireless technologies.

The vibrating gloves utilizing the wireless connectivity such as Bluetooth®, Wi-Fi® and any other small range communication technology to connect with a wireless remote controller or a mobile device having mobile application to control the vibrating glove.

In the preferred embodiment, a mobile device with a software application can also control the various functions of the vibrating gloves. These various functions may be but not limited to control the speed of vibration, changing the color of lightening.

In the preferred embodiment, the user can control the palm area vibration, individual finger vibration, or both simultaneously. There can be multiple vibrational patterns.

In the preferred embodiment, the lightening module comprises at least one LED; the lighting module can offer multi-color lighting. This can help in enhancing the mood and orgasm.

In another embodiment, the glove may be assembled without vibration of the fingertips or the glove may be assembled without vibration of the palm area.

The palm and each fingertip vibrate on the glove.

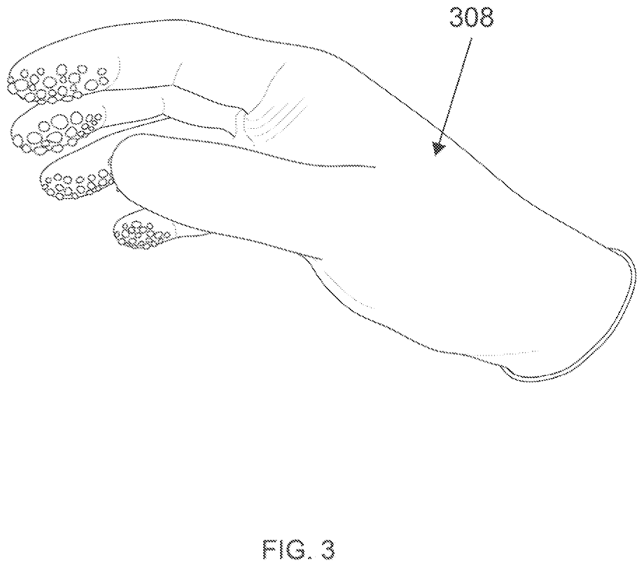

FIG. 3 illustrates the side view 308 of the vibrating glove, according to an embodiment of the present invention. The side view 308 closer to thumb is illustrated in the FIG. 3.

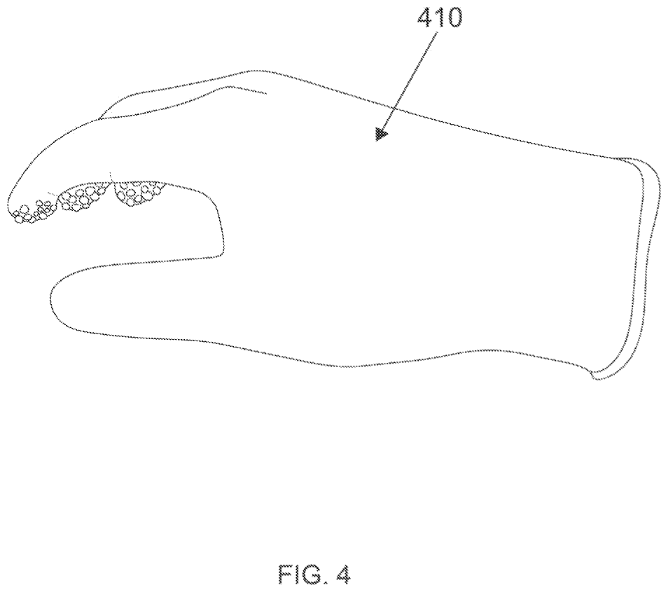

FIG. 4 illustrates the back side 410 view of the vibrating glove, according to an embodiment of the present invention. The back side 410 can be a housing for various modules in one of the embodiment of the present invention.

Operation Modes: There can be multiple modes in which the vibrating gloves can be used.

In one of such mode, when a male is using such vibrating glove. The wearer cups the testicals utilizing the palm vibration and using the fingerprints to stimulate the penis.

In a preferred embodiment, the palm vibration is also when the user grab the penis in his palm and using the fingertips for stimulating the testicals.

In another preferred embodiment, the fingertip vibration is utilized for stimulating the anal region.

In another mode, when a female is using such vibrating glove. The fingertips vibrations can be utilized for massaging the clitoris.

In a preferred embodiment, the fingertips can be inserted into the vagina, while the palm area can stimulate the outer vagina area.

The vibrating gloves are not only used for stimulating the sexual organs. The vibrating gloves can also be used for teasing or stimulating the nipples or arousal areas of men and women body.

The vibrating gloves are washable and water-proof. It is advisable to wash or clean or sanitize the glove.

The vibrating glove is made of material which is food-safe; this means the material is skin safe.

The vibrating glove can also find application while messaging the sore muscles.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention.

Various terms as used herein are shown below. To the extent a term used, it should be given the broadest definition persons in the pertinent art have given that term as reflected in printed publications and issued patents at the time of filing.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention.

1. A vibrating glove comprises:
an elastic glove comprising a textured surface at the palm region and a plurality of finger tips portions having rugged surfaces;
a plurality of vibration motors and an illuminating means;
a rechargeable port connected to a rechargeable battery;
the plurality of vibration motors, the rechargeable battery connected to the rechargeable port, being positioned within the elastic glove under the outer cover; wherein the rechargeable port is present at the wrist portion outside of the vibrating glove;
a wireless module connected to the vibrating motors;
a wireless module to control the vibration mode and illuminating means depending upon the mood of the user, to enjoy the simulation of the body part.

2. The vibrating glove as claimed in claim 1, wherein the battery is removably positioned within the palm portion or in the back of the user.

3. The vibrating glove as claimed in claim 1, wherein the battery is rechargeable using a rechargeable port.

4. The vibrating glove as claimed in claim 1, wherein the plurality of vibration motors to provide haptic feedback and vibrations at multiple intensities.

5. The vibrating glove as claimed in claim 1, wherein the pluralities of vibrating modes are controlled using wireless module.

6. The vibrating glove as claimed in claim 1, where in the plurality of vibration modes, configured to be selected based on the mood of the user.

7. The vibrating glove as claimed in claim 1, wherein the rugged surfaces are distributed on the fingertips and thumbs.

8. The vibrating glove as claimed in claim 1, wherein the illuminating means to provide illuminations of different color and intensities.

9. The vibrating glove as claimed in claim 1, wherein the intensity can also be controlled using a mobile application.
